(19) United States
(12) Patent Application Publication
(10) Pub. No.: US 2010/0262541 A1
(43) Pub. Date: Oct. 14, 2010

(54) CREDIT CARD SECURITY SYSTEM

(75) Inventor: Steven Alan Wolfowitz, Port Elizabeth (ZA)

Correspondence Address: YOUNG & THOMPSON, 209 Madison Street, Suite 500, Alexandria, VA, 22314, US

(73) Assignee: THE CENTURY TRUST, Port Elizabeth (ZA)

(21) Appl. No.: 12/740,755

(22) PCT Filed: Oct. 30, 2008
(86) PCT No.: PCT/ZA08/00100

§ 371 Date: Apr. 30, 2010

(30) Foreign Application Priority Data
Oct. 31, 2007 (ZA) 2007/08760
Nov. 1, 2007 (ZA) 2007/09930
Mar. 20, 2008 (ZA) 2008/02564

(51) Int. Cl. G06Q 40/00; G06F 17/30

(52) U.S. Cl. 705/43; 705/42; 707/769; 707/E17.014; 455/466

(57) ABSTRACT

A system for the prevention of fraud in various financial transactions including a central processing unit (CPU) associated with a financial institution and in communication with a customer database of the institution, the CPU including elements for receiving a telecommunication from a customer communication device, the telecommunication indicating the requirement for a transaction; the database and/or CPU identifying the customer telephone number and matching it with the customer details in the database; the establishment of a match in the matching process triggering activation of the account to permit a transaction of a specified monetary value.

### TECHNICAL FIELD OF THE INVENTION

This invention relates to a system of preventing or reducing credit card and other transaction fraud and the like. This invention further relates to a communication device finding particular application in the pre-validation or pre-verification or pre-authorisation of banking transactions by the beneficiary.

In this patent specification telecommunication will be understood to mean communicating over a distance by cable, telegraph, telephone, cellular phone, satellite phone or broadcasting.

In this specification a card will include a credit, debit, laser or any similar payment device.

### BACKGROUND ART

Credit card fraud can range from using a physically stolen card to make a purchase, to situations where the would-be fraudster has access to the credit card details and uses it to make remote purchases or copies of the card.

An increase in the number of instances of this type of fraud has forced banking and similar institutions to start adopting more and more preventative measures in an attempt to guarantee the security of their clients.

The current measures include alerting a user of any transactions on their accounts, complicated encryptions, security pins and the like.

The drawback of these measures is that most of them focus on the time frame after the fraudulent act, and subsequently they are not preventative in nature.

It is an object of this invention to provide a method of preventing, or at least drastically reducing instances of credit card fraud by introducing a novel preventative measure.

It is a further object of this invention to modify the system for use for the collection of pension payouts or the like. Elderly people may have difficulty in making use of a cellular telephone to send a required sms to notify the bank/institution that they are still alive and to activate the bank's authorisation for release of payment of the elderly person's pre-determined funds (which may be their due pension payout). It is therefore proposed to provide a simplified communication device permitting sending off an sms, encrypted sms, or similar message by means of the use of a limited number of dedicated buttons, rather than requiring a series of numbers to be entered.

Apart from simplifying the procedure for elderly or illiterate people implementation of the systems by governments (and their insurance companies) making payments would significantly reduce the risk of fraud or theft of pension payouts. Accordingly it is a further object of this invention to provide a device for use in such payment systems.

For the purposes of this invention, message via a cellular telephone or satellite network is taken to mean sms, encrypted sms, mms, gprs, 3G, HSDPA or similar.

### DISCLOSURE OF THE INVENTION

A system for the prevention of fraud in various financial transactions including a central processing unit (CPU) associated with a financial institution and in communication with a customer database of the institution, the CPU including means for receiving a telecommunication from a customer communication device, the telecommunication indicating the requirement for a transaction; the database and/or CPU identifying the customer telephone number and matching it with the customer details in the database; the establishment of a match in the matching process triggering activation of the account to permit a transaction of a specified monetary value.

In the preferred form of the invention, the account remains activated for a predetermined time limit.

In one form of the invention, the use of the system relates to credit or debit card transactions and the communication device comprises a cellular telephone.

In the preferred form of the invention the account remains in a dormant state in which no transactions are possible until activated upon receipt of communication from the customer, the account being returned to a dormant state immediately after the transaction has been processed. The account remains activated for a specified time limit only after which it returns to the dormant state if the transaction has not been made by a vendor.

Also in the preferred form of the invention, the system includes means for forwarding a message to the customer's telephone upon completion of the matching process, the message including verification data for inputting by a vendor with whom the customer wishes to transact.

The system ensures that any action or authorization to make a transaction on an account lies in the holder of the account, and not with the financial institution—within the accounts holder's credit or debit limit.

In the preferred form of the invention the financial institution receives a text/sms phone message from the account holder containing relevant information, the CPU interprets the message and identifies the sender and the account linked to the sender/number, the CPU transmits a message to the accounts database of the financial institution to authorise the release of limited funds for a limited time.

In this form of the invention a telephone number of the account holder is listed with the institution upon registration for the service, and the CPU is able to recognize the telephone number and to link the phone number to a specified account and its related card/s.

The CPU may comprise an automated system and may only recognise the last 7 or 9 digits of the incoming number to cater for messages sent to the CPU from other countries.

Alternatively the financial institution may have a facility to change the linked telephone number for a specified time, for instance when an account holder travels to a foreign country or the like.

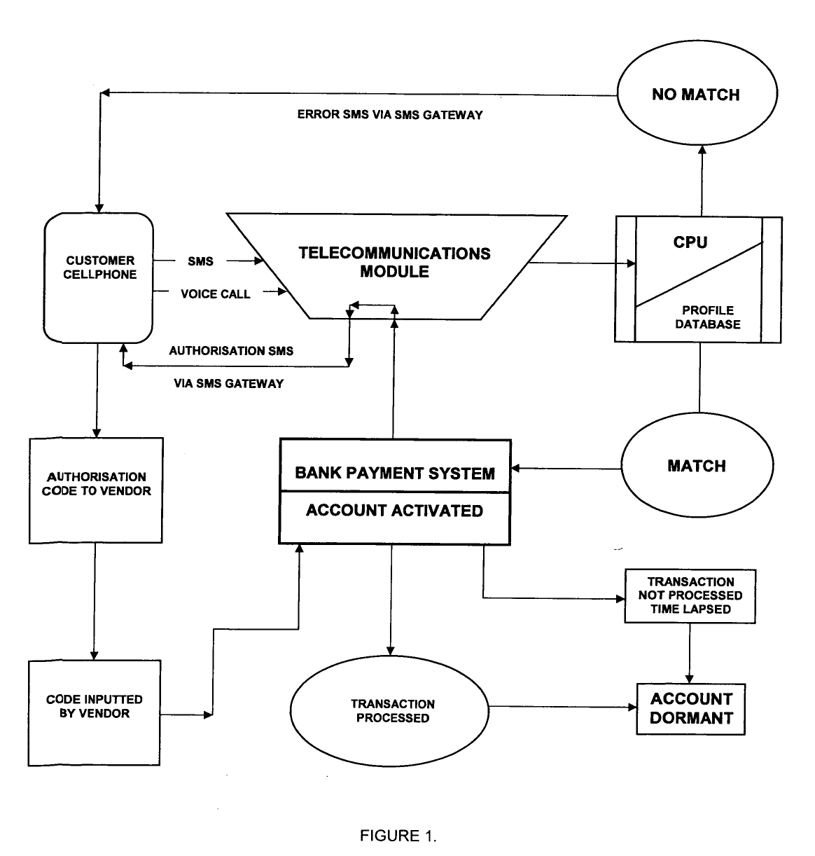

The operation of the system is illustrated in FIG. 1.

In operation, either a text or voice call is sent to a specific telephone number provided by the bank.

1. Upon connection the bank recognizes the incoming number and its CPU computes an algorithm consisting of the last 7 or 9 digits of the customers' number (those numbers excluding the “0” and country code so that it can be used internationally being unique with its local area code included) together with the bank's specified number which the customer must call.
2. This algorithm links the bank's designated phone number and the customer's communication number as maintained in the bank's profile database for the customer.
3. The CPU then links this algorithm with the customer's account and activates the full facility of the customer's account for a predetermined period from its ‘dormant’ state in which only a partial predetermined facility is available.
4. This activated facility will only be available for a predetermined period or until one transaction has been made by any vendor with the account within the predetermined window of opportunity established by the algorithm link.

In another form of the invention the CPU may be voice prompted. In this form the account holder may for instance dial a number, enter a pass code when prompted to do so and subsequently release limited funds for a limited time period.

In situations in which a banking institution relies upon the forwarding of a one-time password which must be entered before a new beneficiary can be created or a transaction processed, it is further desirable to protect against sim-swapping or the like practices. Accordingly in a modification or improvement of the invention, the customer database and or the CPU of the system is telecommunicably or otherwise linked to an automatically up-dated database of sim-swapped mobile telephone numbers, the CPU being adapted to perform a matching procedure to determine whether customer's mobile telephone numbers present in the customer profile database thereof, have been sim-swapped, the bank computer system being further adapted to carry out a verification procedure including the forwarding of a message to the new or sim-swapped number, the account of the customer being maintained in a dormant or partially dormant state until the verification process has been completed.

In the simplest form of the invention, the verification process is simply the elapsing of a pre-determined period (a cooling off period). This period should not need to be for longer than a week to two weeks whereafter the account may be automatically re-activated to its normal facility state. During the dormant period, any request for forwarding of a ‘one-time password’ would simply be ignored by the bank.

The length of the cooling off period will coincide with the time for which these sim-swaps need to be maintained on the database and is determined by the period judged necessary for the legitimate user to become aware of the swap without his knowledge or permission. This ‘publication period’ could be about 1-2 weeks.

The operation of the system in which sim-swapped telephone numbers are checked, is shown in FI. 2.

In operation, either a text or voice call is sent to a specific telephone number provided by the bank;

2. Upon connection the bank recognizes the incoming number and its CPU computes an algorithm consisting of the last 7 or 9 digits of the customers' number (those numbers excluding the “0” and country code so that it can be used internationally being unique with its local area code included) together with the bank's specified number which the customer must call.

3. This algorithm links the bank's designated phone number and the customer's communication number as maintained in the bank's profile database for the customer.

4. The CPU then links this algorithm with the customer's account and checks against its database of all numbers which have been sim-swapped during the past two weeks whether the customer's comms number as recorded in the customer's profile has been sim-swapped during that period.

5. If it has not the CPU activates the full facility of the customer's account for a predetermined period from its ‘dormant’ state in which only a partial predetermined facility is available.

6. This activated facility will only be available for a predetermined period or until one transaction has been made by any vendor with the account within the predetermined window of opportunity established by the algorithm link.

7. If the CPU determines that the customer's profile number has been sim-swapped no transactions with the customer's account may be performed for a pre-arranged period or until the profile is updated.

8. A message is sent to the new (sim-swapped) number to inform the customer that his profile must be updated on account of the sim-swap having taken place.

In an alternative form of the invention, a communication device comprises a handset which incorporates a transmitter for sending messages via a cellular telephone or satellite network, the handset including one or more buttons which, upon depression thereof, sends a message to an institution database on a pre-programmed number. The system performs the same procedure as described above in order to effect transmission of a unique authorisation code to the pension institution and/or the handset.

For the purposes of this invention, message via a cellular telephone or satellite network is taken to mean sms, encrypted sms, mms, gprs, 3G, HSDPA or similar.

In the preferred form, the handset includes a biometric identification device, for example retinal scan, the handset further including a processing unit adapted to convert the biometric identification into a unique number or code for transmission to the pension/banking institution which would be recognised by the bank/institution as emanating solely from the pensioner who must be still alive for the biometric identification to be generated. In this way no pensions could be paid out to “dead people/pensioners.

The handset may include a series of buttons which are uniquely identifiable for use by the owner for various transactions. For example different coloured or shaped buttons may refer to different credit cards or banking institutions. In this form, it is contemplated that a person would have a personal communication device into which his personal banking contact information could be pre-programmed.

Should the device of the invention include a biometric identification facility, it is envisaged that these would be the property of the payor institution and the payee would not be required to possess his or her own device.

In one form of the invention, the device may include a receiver for receiving an acknowledgement or the like of the pending transaction and/or an authorisation code or confirming that the transaction has been processed.

In an example of operation of this system for use with pension payouts:

a) The bank's (pension company's) predetermined communications number to connect to is programmed into the handset;

b) The handset performs a retina (biometric) scan and converts this to a number (code).

c) This number (code) is transmitted after depressing the relevant button on the handset to the pension paying institution whose CPU, after connection, computes the algorithm which includes its own specified comms number and the pensioner's last 7/9 digits of his comms number.

d) The CPU then links the algorithm as before to the customer's account and (as for sim-swaps) checks that the retina code matches that recorded on the customer's profile in its database.

e) If all match the pensioner's account is activated and payment is made into the pensioner's prearranged banking account, after an authorisation code been sent to the pensioner's handset is given to the pension payout agent and inputted into the payment system.

f) No further transactions may be performed for one month (pensioner account dormant).

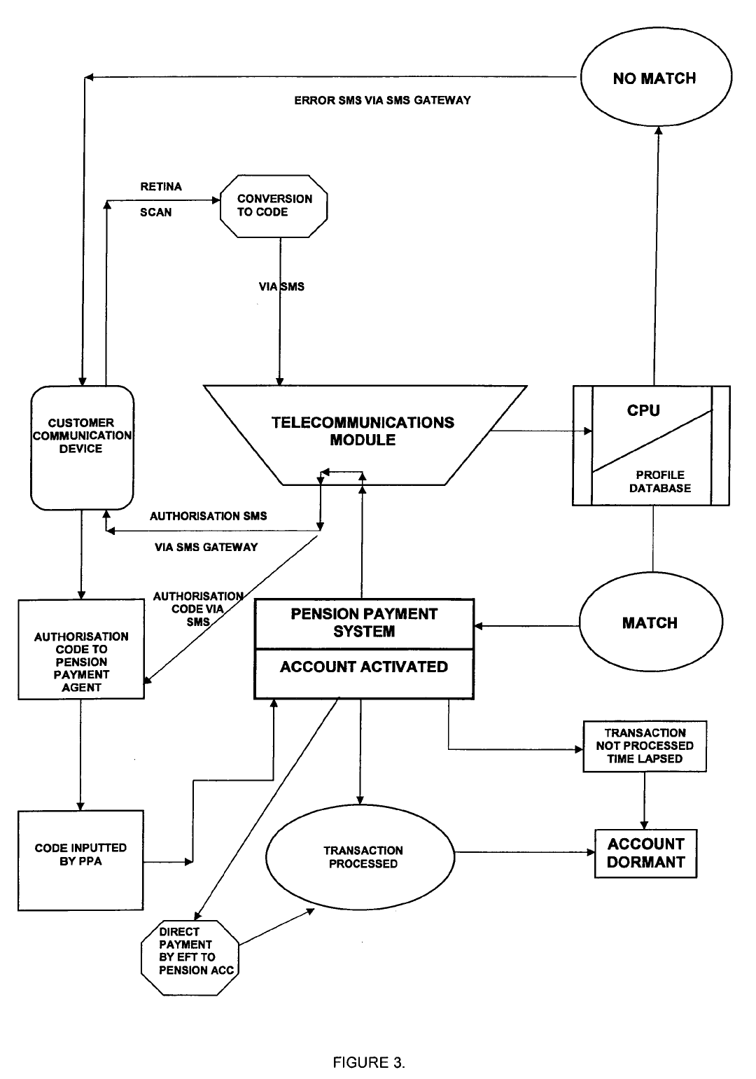

This is illustrated in the flow diagram, FIG. 3.

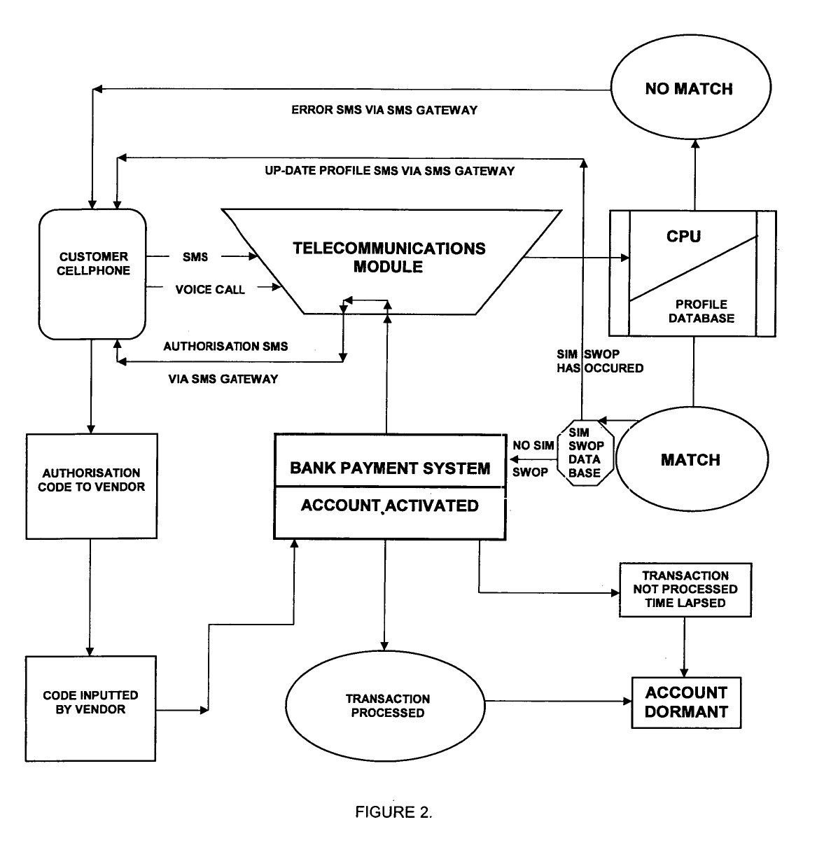

In FIG. 3, the Pension Payout Agent (PPA) is similar to the Vendor in FIGS. 1 and 2 while Pension Payout system may be the bank.

Where the pensioner collects payments from a payout point, steps a) to d) are as above. Thereafter the payment is processed by a pension payout agent:

a) The bank's (pension company's) predetermined communications number to connect to is programmed into the device;
b) The device performs a retina (biometric) scan and converts this to a number (code).
c) This number (code) is transmitted after depressing the relevant button on the device to the pension paying institution whose CPU, after connection, computes the algorithm which includes its own specified comms number and the pensioner's last 7/9 digits of his comms number.
d) The CPU then links the algorithm as before to the customer's account and (as for sim-swaps) checks that the retina code matches that recorded on the customer's profile in its database.
e) If all match the pensioner's account is activated and an authorization message (preferably sms) sent to pension payout agent and/or confirmation sms sent to pensioner.
f) Authorization processed by payout agent and payout made in cash.
g) No further transactions may be performed for one month (pensioner account returns to dormant).

These alternative steps are also illustrated in FIG. 3.

### BEST MODE FOR CARRYING OUT THE INVENTION

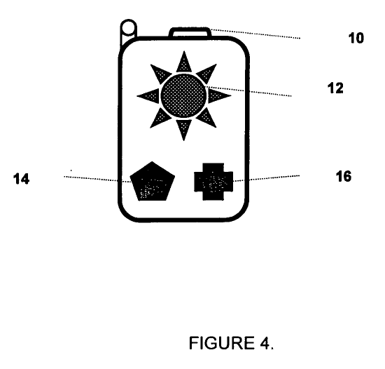

An embodiment of an example of a customer communication device of the invention for use with pension payouts is described below with reference to the accompanying drawing, FIG. 4 which is a plan view of a customer communication device.

In the drawing, a device 10 is effectively a cellular communication device which may be required to include a sim-card or other hardware to permit connection to a cellular telecommunication network.

The device includes a retina scanner 12 which is further adapted to convert the scanned biometric image to a numerical code which is transmitted to the pension institution via sms. This is achieved by the pensioner depressing button 14. Button 16 may be for contacting another institution for example.

The device may further include a screen (not shown) for display of confirmation or other (for example error) messages sent by the institution.

1-31. (canceled)

32. A system for the prevention of fraud in various financial transactions including a central processing unit (CPU) associated with a financial institution and in communication with a customer database of the institution, the CPU including means for receiving a telecommunication from a customer cellular telephone type device, the telecommunication indicating the requirement for a transaction; the database and/or CPU being capable of identifying the customer telephone number and matching it with the customer details in the database characterised in that the customer initiates the process prior to any payment authorisation request by the vendor, and characterised further in that establishment of a match by the matching process triggers activation of the account from a dormant status in which no transactions are possible to an active status in which a transaction for a monetary value specified by the customer.

33. A system according to claim 32 characterised in that the account remains activated for a predetermined time limit during which the customer is able to carry out banking transactions whereafter the account returns to the dormant status.

34. A system according to claim 32 characterised in that the banking transaction comprises a cash withdrawal from an automatic teller machine.

35. A system according to claim 32 characterised in that the system includes means for forwarding a message to the customer's telephone upon completion of the matching process, the message including verification data for inputting by a vendor with whom the customer wishes to transact, together with a standard payment authorisation request.

36. A system according to claim 35 characterised in that the means for forwarding the message comprises a telecommunication module.

37. A system according to claim 32 characterised in that the telecommunication from the customer cellular telephone device is received by the institution at the telecommunication module, the message being in the form of an sms sent via an sms gateway or by a USSD communication to a specific telephone number specified by the bank.

38. A system according to claim 32 characterised in that the customer telecommunication is a voice call.

39. A system according to claim 32 characterised in that the customer telecommunication is a text (sms) message.

40. A system according to claim 32 characterised in that the message contains relevant customer information, the CPU being capable of interpreting the message, identifying the sender (customer) and the bank account linked to the sender telephone number.

41. A system according to claim 32 characterised in that the customer telephone number is listed with the institution upon registration for the service, the CPU being capable of identifying the telephone number and linking the telephone number to a specified account of the customer and the card/s related to that account.

42. A system according to claim 41 characterised in that the CPU identifies the last seven digits of the incoming telephone number.

43. A system according to claim 41 characterised in that the CPU recognizes the last nine digits of the incoming telephone number.

44. A system according to claim 41 characterised in that the listed customer telephone number may be substituted temporarily, should the customer be making use of an alternative number during travel outside of his home country.

45. A system according to claim 32 characterised in that if the CPU matches the customer telephone number to the customer details in the customer database by computing an algorithm comprising of the last seven or more digits of the customer's telephone number and the bank's specified number which the customer has contacted; the algorithm further linking the bank's specified number and the customer's contact number; the CPU further linking the algorithm to the customer's bank account number and activating a payment facility specified by the customer in his message, for a predetermined time period upon correct computation of the algorithm.

46. A system according to claim 32 characterised in that the customer specified payment facility is a portion of the bank permitted credit facility made available by the bank for the customer.

47. A system according to claim 1 characterised in that the CPU further verifies whether or not the customer's listed telephone number has undergone a sim-swap.

48. A system according to claim 47 characterised in that the CPU/or the customer database is telecommunicably linked to an automatically up-dated database of sim-swapped telephone numbers; the CPU being adapted to perform a matching procedure to determine whether customer's mobile telephone numbers present in the customer profile database thereof, have been sim-swapped, the bank computer system being further adapted to carry out a verification procedure including the forwarding of a message to the new or sim-swapped number, the account of the customer being maintained in a dormant or partially dormant state until the verification process has been completed.

49. A system according to claim 47 characterised in that the verification process is the elapsing of a pre-determined time period, during which the account remains dormant and any requests for forwarding a one-time password would be ignored by the bank.

50. A system according to claim 47 characterised in that, in the event that a customer number has been sim-swapped, an sms is forwarded to the customer.
